(19) United States
(12) Patent Application Publication
(10) Pub. No.: US 2024/0181903 A1
(43) Pub. Date: Jun. 6, 2024

(54) APPARATUS AND METHOD FOR CHARGING WIRELESSLY OF A VEHICLE BATTERY

(71) Applicant: JEJU NATIONAL UNIVERSITY INDUSTRY-ACADEMIC COOPERATION FOUNDATION, Jeju-si, Jeju-do (KR)

(72) Inventors: Yeong Jun Choi, Jeju-Si, Jeju-Do (KR); Hwa Rang Cha, Seoul, Seongdong-Gu (KR)

(73) Assignee: JEJU NATIONAL UNIVERSITY INDUSTRY-ACADEMIC COOPERATION FOUNDATION, Jeju-si, Jeju-do (KR)

(21) Appl. No.: 18/285,191

(22) PCT Filed: Mar. 7, 2022
(86) PCT No.: PCT/KR2022/003205

§ 371 Date: Sep. 29, 2023

(30) Foreign Application Priority Data
Mar. 30, 2021 (KR) 10-2021-0041365

(51) Int. Cl. B60L 53/126; B60G 17/018; B60L 53/39

(52) U.S. Cl. CPC B60L 53/126; B60G 17/018; B60L 53/39; B60G 2202/12; B60G 2202/152; B60G 2500/30

(57) ABSTRACT

An apparatus and method for charging wirelessly of a vehicle battery includes a plurality of power receiving coils each located on a suspension, located near wheels of a vehicle, and receiving power transmitted from an external charging system; a voltage detection module configured to detect a power of the plurality of power receiving coils; a suspension driving module configured to drive the suspension to adjust a height of each wheel of the vehicle; and a control module configured to control the suspension driving module based on the voltage detected by the voltage detection module.

### TECHNICAL FIELD

The following description relates to an apparatus and method for charging wirelessly of a vehicle battery.

### BACKGROUND ART

Electric vehicles run on batteries, which require periodic charging to maintain continuous operation.

As a result, there is an increasing focus on developing infrastructure for charging electric vehicle batteries. Various charging methods, such as home chargers, battery replacement, fast-charging device, and wireless charging devices, are available. Additionally, new charging business models are also emerging.

In particular, there is a growing demand for safe and fast charging methods that reduce charging time and enhance convenience. Various contactless charging methods are also being suggested to address the inconvenience of wired charging, which requires plugging a cord into a socket.

FIGS. 1A and 1B illustrate views of a conventional wireless charging system for vehicles.

Referring to FIGS. 1A and 1B, transmission lines capable of supplying power are installed on the surfaces of roads and charging stations, while a device is installed underneath a vehicle V to receive power from a power source 5, enabling wireless power reception.

This wireless power transmission technology transfers power using the principle of mutual induction. It supplies power wirelessly from a transmitting coil 7 embedded in the road to a receiving coil 3 of the vehicle V using magnetic induction and charges the battery.

However, with the conventional wireless charging methods, charging occurs at the center of the vehicle's underside, which makes it easy for foreign substances or cats to enter. Additionally, due to the coil 3 being located in the central part where many essential components of the vehicle are, there is a risk of magnetic flux interfering with other parts, leading to unnecessary eddy current losses. Furthermore, vehicles come in different sizes, and the entry point for charging may easily vary, making the alignment of the receiving coil 3 and transmitting coil 7 challenging.

### DISCLOSURE

### Technical Problem

An object of the present disclosure is to provide an apparatus and method of charging wirelessly of a vehicle battery, wherein a receiving coil is located at a position with relatively few critical vehicle components, preventing damage due to eddy currents.

Furthermore, another object of the present disclosure is to provide an apparatus and method of charging wirelessly of a vehicle battery. This may prevent the ingress of foreign substances by utilizing the suspension of a wheel that is closely attached to the ground. It may allow for charging using only a few of the vehicle's four wheels and uniform charging across each coil when the vehicle is at its lowest position.

The problems to be solved by the present disclosure are not limited to the problems mentioned above, and other problems not mentioned will be clearly understood by those skilled in the art from the description below.

### Solution to Problem

An apparatus for charging wirelessly of a vehicle battery according to one example of the present disclosure includes: a plurality of power receiving coils each located on a suspension, located near wheels of a vehicle, and receiving power transmitted from an external charging system; a voltage detection module configured to detect a power of the plurality of power receiving coils; a suspension driving module configured to drive the suspension to adjust a height of each wheel of the vehicle; and a control module configured to control the suspension driving module based on the voltage detected by the voltage detection module.

The power receiving coil may be connected to a coil spring or an air spring of the suspension.

The apparatus for charging wirelessly of a vehicle battery may further include a magnetic core located inside the coil spring.

The power receiving coil may be the coil spring of the suspension.

The suspension driving module may include four actuators to drive the suspension for each wheel of the vehicle.

The control module may control the suspension driving module so that the plurality of power receiving coils have uniform voltage.

The apparatus for charging wirelessly of a vehicle battery may further include a communication module configured to communicate wirelessly with an external charging system.

A method for charging wirelessly of a vehicle battery according to one example of the present disclosure includes: detecting a charging position of a vehicle with four power receiving coils located near each wheel of the vehicle, and executing fast charging or slow charging based on the charging position of the vehicle.

The detecting charging position may include detecting a number of wheels positioned at four charging points where the four power receiving coils are charged.

The executing fast charging or slow charging may include, if the number of the detected wheels is two, executing slow charging; and if the number of the detected wheels is three, executing fast charging.

The method for charging wirelessly of a vehicle battery may further include detecting a voltage of each of the four power receiving coils; and adjusting a height of the vehicle based on the detected voltage.

The adjusting the height of the vehicle may include driving a suspension of the vehicle to adjust the height of each wheel of the vehicle.

Programs for implementing the various examples of the present disclosure for achieving the above-described tasks may be recorded on a computer-readable recording medium.

Other specific details of the present disclosure are included in the detailed description and drawings.

### Effects of Invention

According to the present disclosure, the coil exists in a location where there are relatively fewer vehicle components, preventing damage from eddy current losses, and by utilizing the suspension of the wheel closely attached to the ground, the risk of foreign substance ingress may be reduced.

Additionally, charging can be achieved using only some of the vehicle's wheels, thereby reducing installation costs, and even when the vehicle is at its lowest position, it may charge at a uniform voltage, preventing the ingress of foreign substances during charging.

### DESCRIPTION OF DRAWINGS

FIGS. 1A and 1B illustrate views of a conventional wireless charging system for a vehicle.

FIG. 2 illustrates a view of the configuration of a charging system using a wireless charging apparatus of a vehicle battery according to an example of the present disclosure.

FIG. 3 illustrates a view of the configuration of a wireless charging apparatus of a vehicle battery according to an example of the present disclosure.

FIGS. 4 and 5 illustrate views showing a state in which a receiving coil is installed in a vehicle suspension.

FIGS. 6A and 6B illustrate views showing a state in which a receiving coil is connected to a vehicle suspension.

FIGS. 7A and 7B illustrate views showing a state in which a receiving coil and a magnetic core are connected to a vehicle suspension.

FIG. 8 illustrates a graph showing the coupling coefficient with respect to the pitch of a receiving coil.

FIG. 9 illustrates a view showing the sequence of a wireless charging method for a vehicle battery according to an example of the present disclosure.

FIG. 10 illustrates a view showing the sequence of fast charging and slow charging according to an example of the present disclosure.

FIG. 11 illustrates a view showing the sequence of a vehicle height adjustment based on charging voltage according to an example of the present disclosure.

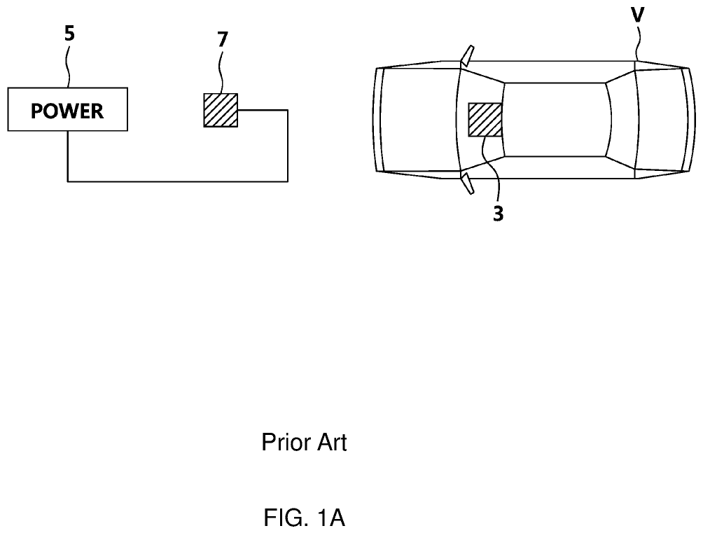

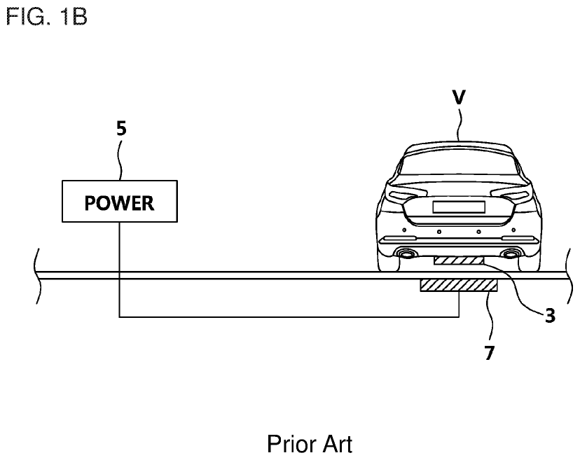

### MODE FOR CARRYING OUT THE INVENTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of the disclosure of this application. Further, although the examples described herein have a variety of configurations, other configurations are possible as will be apparent after an understanding of the disclosure of this application.

Hereinafter, the present disclosure is described in more detail based on the example illustrated in the drawings.

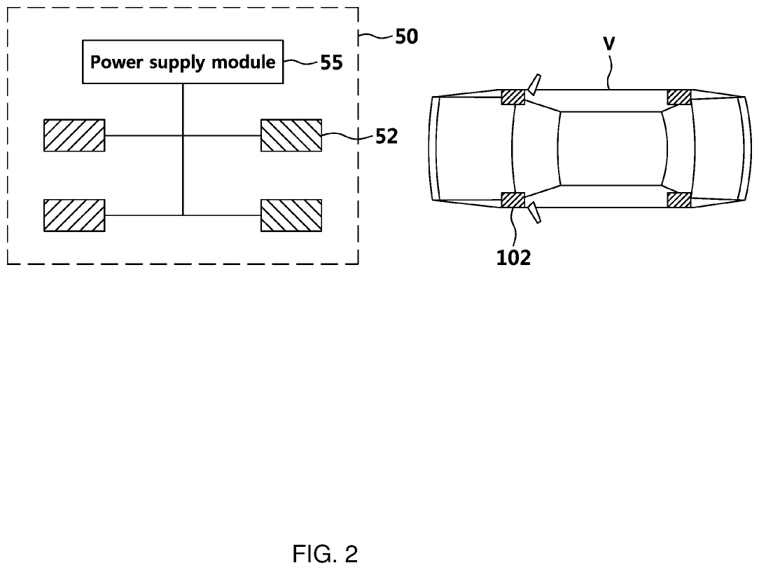

FIG. 2 illustrates a view of the configuration of a charging system using a wireless charging apparatus of a vehicle battery according to an example of the present disclosure.

Referring to FIG. 2, a charging system includes an external charging system 50 installed in a charging station or parking lot to transmit power to charge a vehicle V, and a wireless charging apparatus 100 for a vehicle battery installed in the vehicle V.

The external charging system 50 may include a power supply module 55, a power transmitting coil 52 that wirelessly transmits power, etc. Here, the power transmitting coil 52 may be arranged in four to match the wheels of a vehicle. The size of these power transmitting coils 52 may have an appropriate area to accommodate the size of the vehicle.

When the wheels of the vehicle V enter over the power transmitting coil 52 installed for the purpose of charging the vehicle V, a power receiving coil 102 may be magnetically connected to the power transmitting coil 52. In other words, when the vehicle V equipped with the power receiving coil 102 and a battery (not shown) receives power from the charging system 50 of the vehicle equipped with the power transmitting coil 52 and the power receiving coil 102 installed on a suspension S near the wheels of the vehicle V and the power transmitting coil 52 placed on the ground of the charging system 50 are aligned to face each other, wireless charging can be performed.

The power transmitting coil 52 included in the charging system 50 generates a magnetic field using alternating current power supplied through the power supply module 55 and wiring, and the power receiving coil 102 of the wireless charging apparatus for a vehicle battery installed in the vehicle generates power induced by the magnetic field by the power transmitting coil 52. This enables wireless power transmission and reception to occur. The transmitted and received power is delivered to the charging battery (not shown) and used for charging.

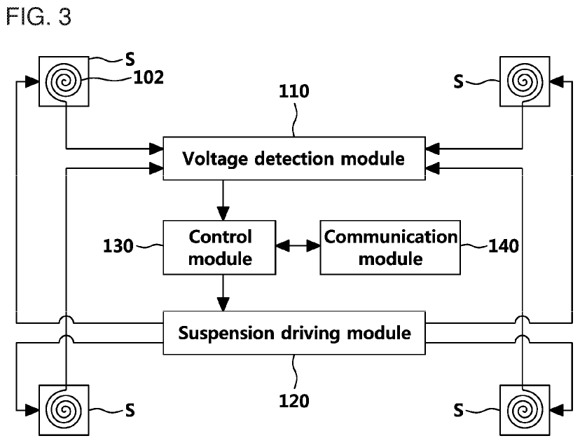

FIG. 3 illustrates a view of the configuration of a wireless charging apparatus for a vehicle battery according to an example of the present disclosure.

Referring to FIG. 3, a wireless charging apparatus for a vehicle battery 100 includes a plurality of power receiving coils 102 each located on a suspension S, a voltage detection module 110, a suspension driving module 120, a control module 130, and a communication module 140.

The power receiving coils 102 are each located on the suspension S near the wheels of a vehicle. The power receiving coil 102 is located in areas of the vehicle where there are relatively few metallic vehicle components, which helps prevent damage to components caused by electromagnetic interference, and since it uses the suspension S of the wheels closely attached to the ground, the risk of foreign substances entering decreases.

At this time, there may be up to four power receiving coils 102, and even if one or two power receiving coils 102 are not operational, charging is still possible using the remaining two or three power receiving coils 102. Depending on the charging operation settings, it can also be configured to charge using only one power receiving coil 102.

Since it is possible to charge using only some of the four wheels, in areas or times where slow charging is possible, such as apartment overnight charging or office daytime charging, charging is possible by placing the transmitting coil 552 only on some wheels, leading to a reduction in installation costs. For example, for vehicles capable of long-duration charging, charging is possible by magnetically connecting the power receiving coil 102 located on the left two wheels or right two wheels with the power transmitting coil 52.

The power receiving coli 102 may be connected to a coli spring or air spring of the suspension, or it may replace the coli spring. This will be described later.

The power receiving coil 102 receives power transmitted from the external charging system 50. As described above, the external charging system 50 may be equipped with the power transmitting coil 52, and one power receiving coil 102 and one power transmitting coil 52 may constitute a single module. By combining one power receiving coil 102 and one power transmitting coil 52 into a single module, it becomes easier to align during charging.

Furthermore, the operation of wireless charging may be configured into various modes. For example, it is possible to set slow charging for one or two modules and fast charging for three or four modules becomes possible. Taking into account the power capacity, it is possible to appropriately adjust the number of modules for receiving coils 102 and transmitting coils 52 being charged. For example, when using four 1 kW modules, the total power becomes 4 kW.

The voltage detection module 110 detects the voltage of each power receiving coil 102. This is to address voltage imbalances among the power receiving coils 102 caused by differences in tire height, variation in road height, and the presence of foreign substances when power is simultaneously transmitted through receiving coils 102 of the plurality of wheels. The voltage detection module 110 may detect the voltage of a connected receiving coil 102 and thus confirm the voltage imbalances among each of the power receiving coils 102.

The suspension driving module 120 drives the suspension S to adjust the height for each wheel of the vehicle. In particular, it is desirable for the suspension driving module 120 to be equipped with four actuators (not shown) to drive the suspension S individually for each wheel of the vehicle.

In other words, in order to adjust the height of each wheel of the vehicle individually, actuators may be installed corresponding to each wheel. This allows independent height control of the suspension S for each wheel of the vehicle. As the vehicle can be charged in the lowest possible state so that each received voltage is uniform, it can prevent foreign substances from entering during charging. For example, because the vehicle can be lowered, it can prevent animals such as cats from entering underneath the vehicle, and it can also prevent foreign substances from getting stuck between the transmitting coils 52 and receiving coils 102.

The control module 130 may control the suspension driving module 120, communication module 140, etc.

For example, the control module 130 controls the suspension driving module 120 based on the voltage detected by the voltage detection module 110. This means that the control module 130 controls the suspension driving module 120.

Furthermore, the control module 130 may exchange information about the charging status through the communication module 140. This means that the control module 130 controls the suspension driving module 120 based on the transmission voltage. Additionally, when voltage adjustment is necessary, the control module 130 may control the suspension driving module 120 to adjust the height of the suspension S.

By controlling the suspension driving module 120 with the control module 130, the plurality of power receiving coils 102 may maintain a uniform voltage. As a result, if foreign substances get stuck in the vehicle's wheels, or if the road surface is uneven causing different heights for the four wheels of the vehicle, the control module 130 may independently control the suspension driving module 120 to adjust the height of the vehicle. This allows for maintaining a consistent distance between the transmitting coil 52 and the receiving coil 102 and ensuring the transmitted and received power is uniform.

The communication module 140 wirelessly communicates with an external charging system. During this, through the communication module 140, information and data regarding the charging status between the transmitting coil 52 and receiving coil 102 may be communicated.

When the power transmission and reception between the transmitting coil 52 and receiving coil 102 is uneven through the communication module 140, the information about this uneven power transmission and reception is sent to the control module 130 via the communication module 140. The control module 130 then independently controls the suspension driving module 120 to adjust the height of each suspension S to ensure uniform power transmission and reception.

At this time, the communication module 140 may wirelessly communicate with an external charging system using technologies such as Bluetooth, Zigbee, Near Field Communication, Wibree, and WiFi. It should be understood, however, that the invention is not limited to just these short-range wireless communication methods, and it would be apparent to those skilled in the art that other wireless communication techniques may also be employed.

In the following, a detailed example of the power receiving coil 102 installed in the vehicle's suspension S will be described.

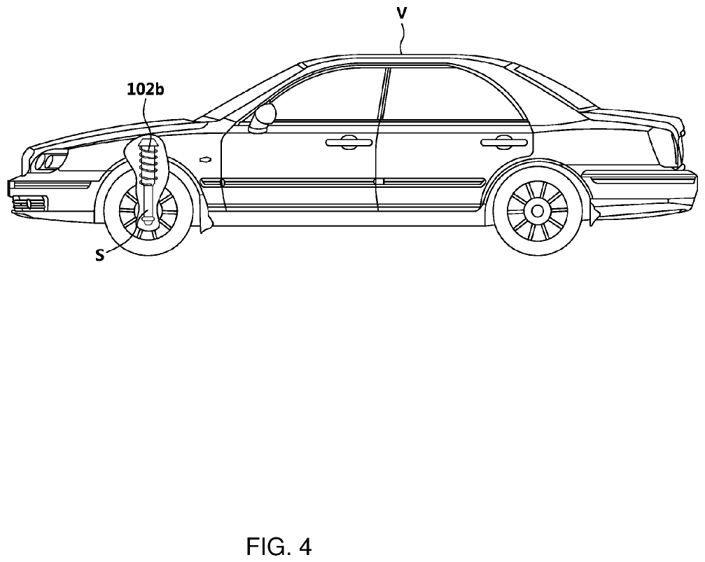

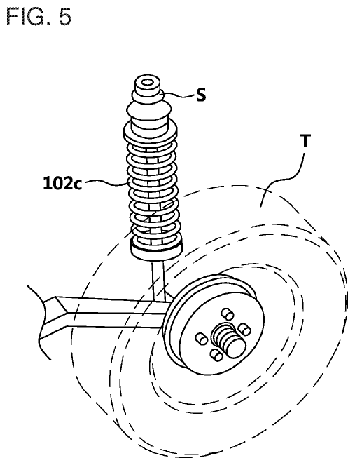

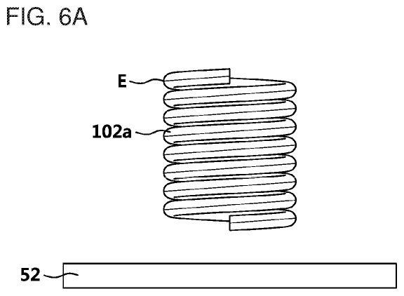

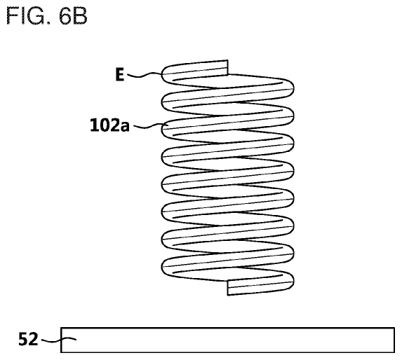

FIGS. 4 and 5 illustrate views showing a state in which a receiving coil is installed in a vehicle suspension. Additionally, FIGS. 6A and 6B illustrate views showing a state in which a receiving coil is connected to a vehicle suspension.

As described above, a power receiving coil 102 may be located on a suspension S located near the wheels of a vehicle V. The installation of the power receiving coil 102 may be implemented in three main ways.

Referring to FIG. 5, in one example, a B-type power receiving coil 102b may be connected to an air spring of the air suspension, which is a type of suspension S. The air spring is equipped with a compression section that can be compressed and/or tensioned to adjust the length of the suspension S, and the B-type power receiving coil 102b may be positioned on the exterior of this compression section. Here, the B-type power receiving coil 102b refers to a coil that is positioned and connected to the exterior of the air spring of the air suspension.

Referring to FIG. 5, in another example, a C-type power receiving coil 102c may replace the coil spring of the suspension S. That is, the C-type power receiving coil 102c becomes the coil spring. The C-type power receiving coil 102c does not merely attach to the coil suspension but directly replaces the coil spring of the coil suspension. Consequently, it is preferable for the C-type power receiving coil 102c to have a thicker dimension. Here, the C-type power receiving coil 102c refers to the coil that replaces the coil spring of the coil suspension.

Referring to FIGS. 6A and 6B, in another example, a A-type power receiving coil 102a may be connected to a coil spring E. Here, Since the A-type power receiving coil 102a is connected to the coil spring E, it compresses in response to the compression of the coil spring E of the coil suspension and tensions in accordance with the tension of the coil spring E. Here, the A-type power receiving coil 102a refers to a coil that is positioned on and connected to the coil spring of the coil suspension.

Because such power receiving coils 102a, 102b, 102c according to various examples are located on the suspension S, the likelihood of foreign matter entering between components involved in the transmission and reception of power is reduced. Consequently, charging tends to occur in areas with fewer metallic components, and the risk of heat generation due to eddy current losses in the bus bar of the battery located underneath the vehicle is diminished.

In particular, it is possible to execute charging such that each receiving coil 102 receive the same voltage from the transmitting coil 52 when the vehicle's height is at its lowest, thereby preventing the ingress of foreign materials during the charging process.

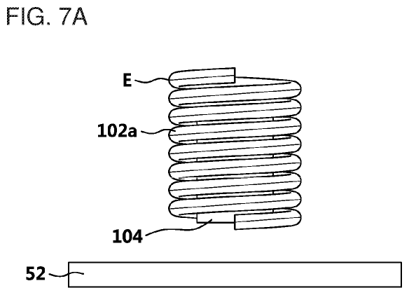

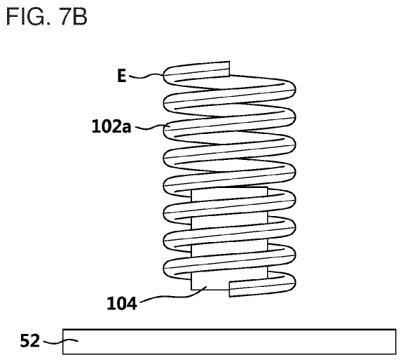

FIGS. 7A and 7B illustrate views showing a state in which a receiving coil and a magnetic core are connected to a vehicle suspension.

Referring to FIGS. 7A and 7B, a magnetic core 104 may be positioned within the A-type power receiving coil 102a connected to the coil spring E of the suspension, as previously described. That is, the magnetic core 104 may be located within the coil spring E.

If the A-type power receiving coil 102a is placed on the suspension S, there exists an empty space within the coil spring E, allowing for the addition of the magnetic core 104. Similarly, when replacing the coil spring E of the suspension S with the B-type power receiving coil 102b, the magnetic core 104 may be included inside the B-type power receiving coil 102b.

In conventional wireless charging methods, positioning the magnetic core 104 is challenging due to the spatial constraints. However, according to the present disclosure, since the power receiving coil 102 is located in the suspension, installing the magnetic core 104 is much easier. Consequently, it is possible to increase the magnetic flux as well as the coupling coefficient.

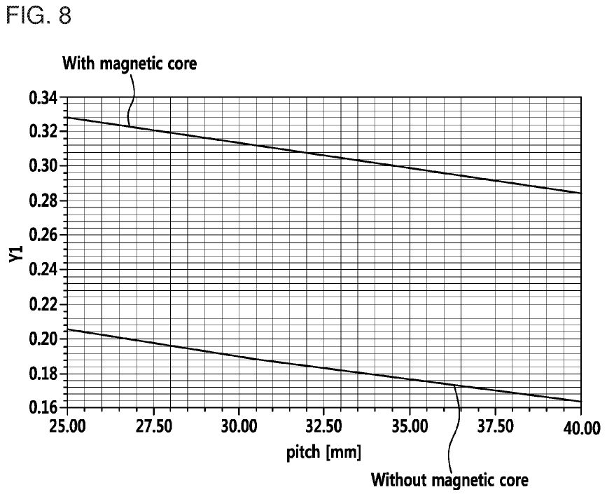

FIG. 8 illustrates a graph showing the coupling coefficient with respect to the pitch of a receiving coil.

Referring to FIG. 8, it can be confirmed that increasing the pitch between the coils results in an increase in the coupling coefficient. Specifically, when the spacing between the coils is expanded from 25 mm to a distance of 40 mm with an interval of 2.5 mm, it can be confirmed that the coupling coefficient decreases.

Such an increase in the coupling coefficient implies a rise in the coupling degree between the transmitting coil 52 and the receiving coil 102. Here, if the voltage of the receiving coil 102 does not reach a specified set value, the coupling coefficient may be increased by compressing the receiving coil 102.

Especially, when there is a magnetic core, it can be confirmed that the coupling coefficient increases significantly at the same pitch.

Therefore, not only one transmitting coli 52 and one receiving coil 102 be modularized for each wheel, but an additional magnetic core 104 may also be added to the modularized configuration. This allows for a significant increase in magnetic flux and coupling coefficient to be achieved.

Additionally, the height of the suspension S may be adjusted independently for each wheel, allowing for voltage adjustment. Therefore, even if foreign substances are present or the charging space surface is uneven, a consistent charging voltage may be maintained. In other words, the battery may be charged without being affected by the tire condition, foreign materials, or road surface state.

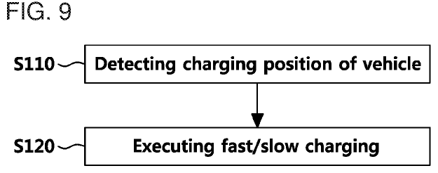

FIG. 9 illustrates a view showing the sequence of a wireless charging method for a vehicle battery according to an example of the present disclosure.

Referring to FIG. 9, the method for charging wirelessly a vehicle battery according to an example of the present disclosure includes detecting the charging position of a vehicle equipped with four power receiving coils located near each wheel of the vehicle (S110) and executing either fast charging or slow charging based on the charging position of the vehicle (S120).

For example, when detecting the charging position, the number of wheels located at four charging points where the four power receiving coils are being charged may be detected. Additionally, when executing fast charging or slow charging, if the number of detected wheels is two, the slow charging may be executed, and if the number of wheels is three or more, the fast charging may be executed. The operation of such charging mode will be detailed later.

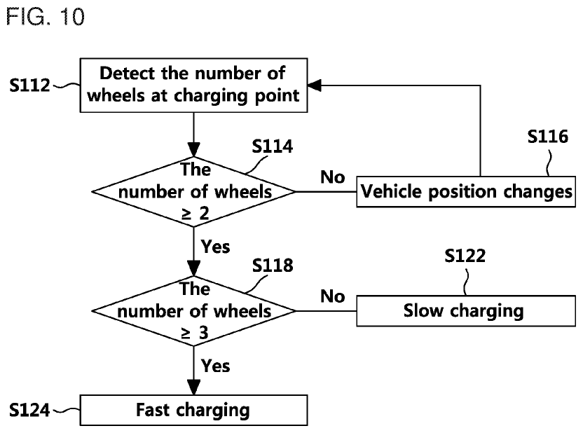

FIG. 10 illustrates a view showing the sequence of fast charging and slow charging according to an example of the present disclosure.

Referring to FIG. 10, the number of wheels at the charging point where the power is transmitted and received by the receiving coil 52 may be detected (S112). Here, the number of wheels may be detected using sensors or confirmed through wireless communication.

Typically, the number of wheels of a car is four or more, and since an equal number of wheels are arranged on both sides, fast charging is executed (S124) when the number of detected vehicle wheels is between 3 to 4.

More specifically, if the number of detected wheels is less than two (S114, No), it is determined that charging is difficult and the position of the vehicle is changed (S116).

If the number of detected wheels is two or more (S114, Yes), the number of detected wheels is checked again (S118).

In this case, if the number of detected wheels is two (S118, No), power can be received from two transmitting coils 52, so it is determined that charging is possible and slow charging is executed (S122). In situations where long-term charging is required, only the two wheels on one side may be positioned over the transmitting coil 52.

In addition, if the number of wheels detected is three or more (S118, Yes), fast charging is executed (S124). Generally, all four wheels would be positioned over the transmitting coil 52, but considering factors like the vehicle's parking, it can be set to execute fast charging even if only three wheels are positioned over the transmitting coil 52.

Therefore, even if some wheels enter the charging point where the power transmitting coil 52 is located, charging can still be done.

Additionally, when multiple wheels are charged simultaneously, they may have a uniform voltage and at the same time, by lowering the vehicle as much as possible within the range where power reception is possible, the ingress of foreign substances can be prevented.

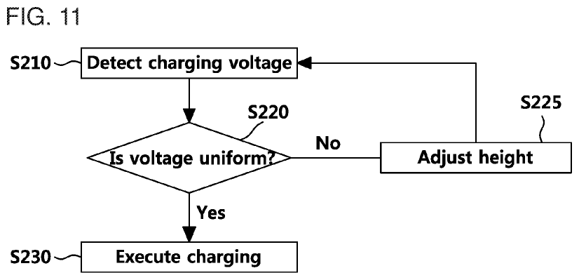

FIG. 11 illustrates a view showing the sequence of a vehicle height adjustment based on charging voltage according to an example of the present disclosure.

Referring to FIG. 11, the charging voltage is detected (S210), and it is checked whether the voltage is uniform during charging (S220). After adjusting the height (S225), charging may be executed to maintain a uniform voltage. That is, each voltage of the power receiving coil is detected, and the height of the vehicle is adjusted based on the detected voltage. This enables the vehicle's height to be lowered while charging at a uniform voltage.

In this case, when adjusting the height, the vehicle's suspension is operated to adjust the height for each wheel of the vehicle. Consequently, it is possible to adjust the height independently for each wheel of the vehicle and address voltage imbalances between the receiving coils 102 caused by difference in tire height, road height, and the ingress of foreign substances.

Although the description has been made with reference to the illustrated embodiments of the present invention as described above, these are merely examples, and those skilled in the art to which the present invention belongs can variously It will be apparent that other embodiments that are variations, modifications and equivalents are possible. Therefore, the true technical protection scope of the present invention should be determined by the technical spirit of the appended claims.

What is claimed is:

1. An apparatus for charging wirelessly of a vehicle battery, comprising:
a plurality of power receiving coils each located on a suspension, located near wheels of a vehicle, and receiving power transmitted from an external charging system;
a voltage detection module configured to detect a power of the plurality of power receiving coils;
a suspension driving module configured to drive the suspension to adjust a height of each wheel of the vehicle; and
a control module configured to control the suspension driving module based on the voltage detected by the voltage detection module.

2. The apparatus of claim 1,
wherein the power receiving coil is connected to a coil spring or an air spring of the suspension.

3. The apparatus of claim 2, further comprising:
a magnetic core located inside the coil spring.

4. The apparatus of claim 1,
wherein the power receiving coil is the coil spring of the suspension.

5. The apparatus of claim 1,
wherein the suspension driving module comprises:
four actuators to drive the suspension for each wheel of the vehicle.

6. The apparatus of claim 1,
wherein the control module controls the suspension driving module so that the plurality of power receiving coils have uniform voltage.

7. The apparatus of claim 1, further comprising:
a communication module configured to communicate wirelessly with an external charging system.

8. A method for charging wirelessly of a vehicle battery, comprising:
detecting a charging position of a vehicle with four power receiving coils located near each wheel of the vehicle, and
executing fast charging or slow charging based on the charging position of the vehicle.

9. The method of claim 8,
wherein the detecting charging position comprises:
detecting a number of wheels positioned at four charging points where the four power receiving coils are charged.

10. The method of claim 9,
wherein the executing fast charging or slow charging comprises:
if the number of the detected wheels is two, executing slow charging; and
if the number of the detected wheels is three, executing fast charging.

11. The method of claim 8, further comprising:
detecting a voltage of each of the four power receiving coils; and
adjusting a height of the vehicle based on the detected voltage.

12. The method of claim 11,
wherein the adjusting the height of the vehicle comprises:
driving a suspension of the vehicle to adjust the height of each wheel of the vehicle.
